(19) United States
(12) Patent Application Publication
(10) Pub. No.: US 2010/0132529 A1
(43) Pub. Date: Jun. 3, 2010

(54) WEB TRANSFER APPARATUS

(75) Inventor: Yasuhiro MIYAZAKI, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/620,819

(22) Filed: Nov. 18, 2009

(30) Foreign Application Priority Data
Nov. 28, 2008 (JP) 2008-304618

(51) Int. Cl. B26D 5/20

(52) U.S. Cl. 83/649

(57) ABSTRACT

A web transfer apparatus includes an unwinding section unwinding a web wound into a roll-shape, a transfer roller section transferring the web on a predetermined web transfer path, a wind-roller section changing a transfer direction of the web by winding the web along the surface thereof, a cutter arranging on the downstream side of the arrangement position of the wind-roller section on the web transfer path, and cutting the web in units of regular sizes, and a web transfer control section driving-controlling the unwinding section, transfer roller section, wind-roller section, and cutter. The wind-roller section and cutter are arranged in such a manner that an interval corresponding to a length offset from a length of an integral multiple of a length of a cut sheet cuts in units of the regular sizes.

### CROSS-REFERENCE TO RELATED APPLICATIONS

This application is based upon and claims the benefit of priority from prior Japanese Patent Application No. 2008-304618, filed Nov. 28, 2008, the entire contents of which are incorporated herein by reference.

### BACKGROUND OF THE INVENTION

1. Field of the Invention

The present invention relates to a web transfer apparatus for changing the transfer direction of a web by means of a winding roller section to transfer the web, and cutting the transferred web into sheet form by means of a cutter.

2. Description of the Related Art

There is a technique for transferring a belt-shaped web such as rolled paper or the like, and cutting the web by means of a cutter. In this technique, a winding roller for changing the transfer direction of the web is provided in the transfer path of the web. During the transfer of the web, the web is wound along the winding roller, and the transfer direction thereof is changed. As long as the web is being transferred, a wind-kink of the web, i.e., the web in the state where the web is bent along the curve of the outer circumferential surface of the winding roller never occurs. However, in the standby state, if the transfer of the web is at a standstill, the web is brought into a state where the web is wound along the winding roller, whereby a wind-kink occurs.

When the web is cut by a cutter at the wind-kink part of the web, the cut end part is brought into a state where the web is bent by the wind-kink as shown in, for example, FIG. 7. Thus, if the cut end part 2 of the web 1 is transferred in the bent state to an ejection roller pair 3 on the downstream side of the cutter, it becomes impossible for the ejection roller pair 3 to pinch and send the cut end part 2 of the web 1, and there is the strong possibility of a malfunction such as occurrence of a jam or the like being caused.

A technique for preventing the wind-kink from occurring is disclosed in, for example, Jpn. Pat. Appln. KOKAI Publication No. 2005-313410. It is disclosed in Jpn. Pat. Appln. KOKAI Publication No. 2005-313410 that in a long medium printing device provided with a transfer roller for transferring a tube on a transfer path with a curved line, platen-roller, pinch roller, thermal head for printing character data, and the like on the tube, and cutter for cutting the printed tube to a predetermined length, it is possible to prevent a curve-kink from being caused in the tube by transferring the tube in a state where the tube is not positioned on the curved line after an elapse of a predetermined rewind time from completion of the cutting.

### BRIEF SUMMARY OF THE INVENTION

A web transfer apparatus according to a first aspect of the present invention comprises an unwinding section configured to unwind a web wound into a roll-shape; a transfer roller section configured to transfer the web on a predetermined web transfer path; a wind-roller section configured to change a transfer direction of the web by winding the web along the surface thereof; a cutter arranged on the downstream side of the arrangement position of the wind-roller section on the web transfer path, and configured to out the web in units of regular sizes; and a web transfer control section configured to drive-control the unwinding section, transfer roller section, wind-roller section, and cutter, wherein the wind-roller section and cutter are arranged in such a manner that an interval corresponding to a length offset from a length of an integral multiple of a length of a cut sheet cuts in units of the regular sizes.

A web transfer apparatus according to a second aspect of the present invention comprises an unwinding section configured to unwind a web wound into a roll-shape; a transfer roller section configured to transfer the web on a predetermined web transfer path; a wind-roller section configured to change a transfer direction of the web by winding the web; a cutter arranged on the downstream side of the arrangement position of the wind-roller section on the web transfer path, and configured to cut the web in units of regular sizes; a web transfer control section configured to drive-control the unwinding section, transfer roller section, wind-roller section, and cutter; and a roller moving mechanism configured to change the arrangement position of the wind-roller section in such a manner that an interval between the wind-roller section and cutter becomes a length offset from a length of an integral multiple of a length of a cut sheet cuts in units of the regular sizes.

A web transfer apparatus according to a third aspect of the present invention comprises an unwinding section configured to unwind a web wound into a roll-shape; a transfer roller section configured to transfer the web on a predetermined web transfer path; a wind-roller section configured to change a transfer direction of the web by winding the web; a cutter arranged on the downstream side of the arrangement position of the wind-roller section on the web transfer path, and configured to cut the web in units of regular sizes; and a web transfer control section configured to drive-control the unwinding section, transfer roller section, wind-roller section, and cutter, wherein distal end position of the web in the standby state is set in such a manner that a web length from the wind-roller section in the standby state to the distal end of the web becomes a length offset from a length of an integral multiple of a length of a cut sheet cuts in units of the regular sizes.

### BRIEF DESCRIPTION OF THE SEVERAL VIEWS OF THE DRAWING

FIG. 1 is a configuration view showing a first embodiment of a web transfer apparatus according to the present invention.

FIG. 2 is a view for explaining the normal ejection in a state where a wind-kink is present in the vicinity of the midway of a cut sheet in the web transfer apparatus.

FIG. 3 is a view showing a shift of an offset part of a wind-kink position in a web made by the web transfer apparatus.

FIG. 4 is a configuration view of a main part showing a second embodiment of a web transfer apparatus according to the present invention.

FIG. 5 is a view showing an example of a mechanism which enables arrangement positions of first to third rollers to be changed in another embodiment of a web transfer apparatus according to the present invention.

FIG. 6 is a view showing another embodiment of a web transfer apparatus.

FIG. 7 is a view for explaining the fact that a malfunction such as occurrence of a jam or the like is caused in a state where a cut end part of a web is bent in the prior art.

### DETAILED DESCRIPTION OF THE INVENTION

A first embodiment of the present invention will be described below with reference to the accompanying drawings.

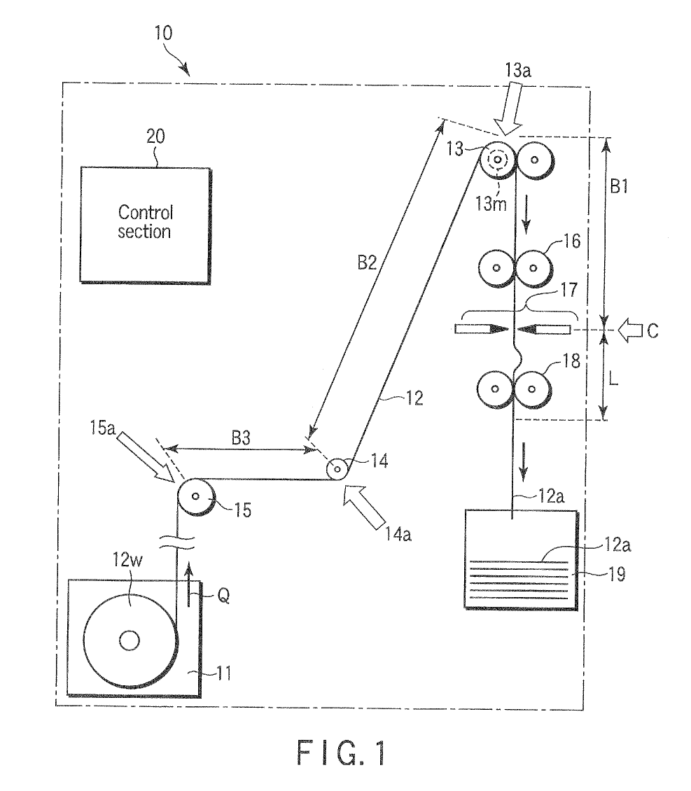

FIG. 1 shows a configuration view of a web transfer apparatus. This web transfer apparatus 10 is applicable to, for example, a line head ink-jet printer. In the apparatus 10 shown in FIG. 1, a print head, drum, and the like are omitted, and only rollers, a cutter, and the like are shown.

The web transfer apparatus 10 is provided with an unwinding section 11. A web 12w formed by winding a belt-shaped web 12 into a roll-like shape is rotatably attached to the unwinding section 11. The unwinding section 11 sends the web 12 off the web 12w in the direction indicated by an arrow Q. A mechanical or magnetic rotation brake is incorporated in the unwinding section 11. The rotation brake maintains the web 12 transferred along a transfer path at given tension without loosening the web 12.

The web transfer apparatus 10 is provided with a first roller pair 13 serving as a winding roller section, second roller 14, and third roller 15. The first roller pair 13, second roller 14, and third roller 15 are provided in the order mentioned from the downstream side of the transfer of the web 12 toward the upstream side thereof.

The first to third rollers 13 to 15 are provided for the purpose of changing the transfer direction of the web 12. In the first roller pair 13, a winding angle of the web 12 is set at the largest value. The first roller pair 13 is arranged closest to a sheet cutter (hereinafter referred to as a cutter) 17. The second roller 14 is formed in such a manner that the roller diameter thereof is the smallest of all the first to third rollers 13 to 15. A motor 13m is attached to a shaft of the first roller pair 13.

A roller pair 16 and a cutter 17 are provided on the downstream side of the first roller pair 13, and an ejection roller pair 18 is provided on the further downstream side of the roller pair 16 and cutter 17. The roller pair 16, cutter 17, and ejection roller pair 18 are arranged in a form of a line. An ejection section 19 is provided on the ejection side of the ejection roller pair 18. The rollers are provided on the downstream side of the roller pair 16. By means of all the above-mentioned members, the web 12 is taken out of the unwinding section 11, reaches the arrangement position of the cutter 17 through the third roller 15, the second roller 14, the first roller pair 13, and the roller pair 16, is cut by the cutter 17, and is thereafter sent to the ejection section 19 through the ejection roller pair 18 as cut sheets 12a.

A control section 20 drive-controls, for example, the motor 13m attached to the shaft of the first roller pair 13. The motor 13m provides drive force for transferring the web 12 to the shaft of the first roller pair 13. The motor 13m transfers the web 12 at a predetermined speed by rotating the first roller pair 13. The first roller pair 13 is a tension roller for applying tension to the web 12.

The control section 20 continuously rotation-controls the first roller pair 13 in synchronization with the web transfer. The control section 20 counts encoder signals generated in synchronization with the travel distance of the web 12, and controls the timing of cutting the web 12 by the cutter 17 on the basis of the counted value. The control section 20 controls the cutting timing of the web 12, and cuts the web 12 into cut sheets 12a of a predetermined length.

The control section 20 controls the mechanical or magnetic rotation brake to vary, for example, the brake torque to be applied to the shaft of the first roller pair 13, and apply the brake torque suitable for a wound roll diameter of the web 12w in the unwinding section 11 to the shaft of the first roller pair 13. As a result, of this, as for the web 12w, constant tension is applied to the web 12 unwound from the web 12w whatever the wound diameter may be. In this case, the control section 20 calculates and obtains the wound diameter of the web 12w in the unwinding section 11 from the rotational speed of the web 12w in the unwinding section 11 at a given radius, and a transfer speed of the web 12 detected at the other part. The wound diameter of the web 12w may be directly detected by means of a separately provided sensor.

When this apparatus 10 is applied to, for example, a line head ink-jet printer, in the unwinding section 11, the web 12 is wound around, for example, a large-diameter drum, and the motor 13m is rotation-driven with constant tension applied to the web 12. This apparatus 10 prevents the slippage of the web 12, and transmits the drive force of the motor 13m to the shaft of the first roller pair 13 to transfer the web 12 at a desired speed. In the line head ink-jet printer, a print head is arranged at a proximity position of the large-diameter drum along the outer diameter of the drum. This apparatus 10 carries out ink ejection control of the print head on the basis of the pulse synchronized with the transfer speed of the web 12.

The web 12 sent from the unwinding section 11 is wound around a drum through each free roller. Besides, rollers are appropriately arranged in accordance with the layout of the cutter 17, ejection section 19, and the like, whereby the transfer path of the web 12 is constructed.

The cutter 17 includes, for example, two linear cutting instruments. The cutter 17 causes the two cutting instruments to carry out reciprocating motion in the opposed directions, and cuts the web 12 by the shearing force of the respective instruments. The cutter 17 is a so-called guillotine cutter.

In this apparatus 10, when the web 12 is cut by the cutter 17 without stopping the transfer of the web 12 on the upstream side of the first roller pair 13 imparting transfer drive force to the web 12, the control section 20 reduces/stops rotation of the rollers on the downstream side of the roller pair 16 before the cutter 17 is operated. As a result of this, the transfer of the web 12 in the vicinity of the cutter 17 is brought into a stopped state for an instant. In this state, the control section 20 causes the cutter 17 to carry out the cutting operation of the web 12. After the web 12 is cut, the control section 20 accelerates the roller on the downstream side of the roller pair 16 to restore the transfer speed of the web 12 to the original transfer speed thereof.

The control section 20 rotation-controls the first roller pair 13 continuously in synchronization with the transfer of the web 12.

The control section 20 counts the encoder signals generated in synchronization with the travel distance of the web 12, and controls the timing of cutting the web 12 by the cutter 17 on the basis of the counted value. The control section 20 controls the cutting timing of the web 12, and cuts the web 12 into cut sheets 12a of a predetermined length. By virtue of this control, this apparatus 10 makes it possible to carry out a printing operation without lowering the overall throughput.

The cut sheet 12a is ejected to the ejection section 19 by the ejection roller pair 18.

The cut length of the web 12 to be cut is such that a length of a short side of a regular size, for example, the paper size A4 is made the standard, and the standard length is made the minimum cut length L. When the web 12 is cut on a cut cycle twice the minimum cut length L, the cut sheet 12a is given a length of the long side of the paper size A3.

When the state where the web 12 is wound along the first to third rollers 13 to 15 with tension applied thereto continues for a long period of time in a state where the web transfer is stopped, wind-kinks occurs on the web 12 at positions at which the web 12 is wound along the surfaces of the first to third rollers 13 to 15. Each of the wind-kinks of the web 12 is formed into a shape bent along the curve of the surface of each of the first to third rollers 13 to 15. Each of the wind-kinks of the web 12 occurs centering around the extreme point of the curved part of each of the first to third rollers 13 to 15 along which the web 12 is wound in contact with the surface of each of the rollers 13 to 15. The extreme point of the curved part in each of the wind-kinks of the web 12 corresponds to each of the positions of the peaks 13a, 14a, and 15a of the wind-kinks.

Parameters determining the wind-kink associated with the apparatus 10 include the radii of the first to third rollers 13 to 15 along which the web 12 is wound, and the tension acting on the web 12. The wind-kink occurring on the web 12 is due to the unbalance in the plastic deformation amount resulting from the fact that the front surface and back surface of the one web 12 at the winding surface differ from each other in the tensile deformation amount. Accordingly, the smaller the radii of the first to third rollers 13 to 15, and the like, or the larger the tension acting on the web 12, the larger the wind-kinks occurring on the web 12 become.

The web 12 is cut into a sheet-like shape by the cutter 17, and the cut sheet is transferred to the ejection roller pair 18 in the state where the wind-kink has occurred in the web 12 in some cases. In this case, if a wind-kink occurs on the cut end side of the cut sheet 12a as shown in FIG. 7, the cut sheet 12a deviates from the nip-line of the ejection roller pair 3 to shift to the outside of the transfer path. As a result of this, a malfunction of occurrence of a so-called jam is caused.

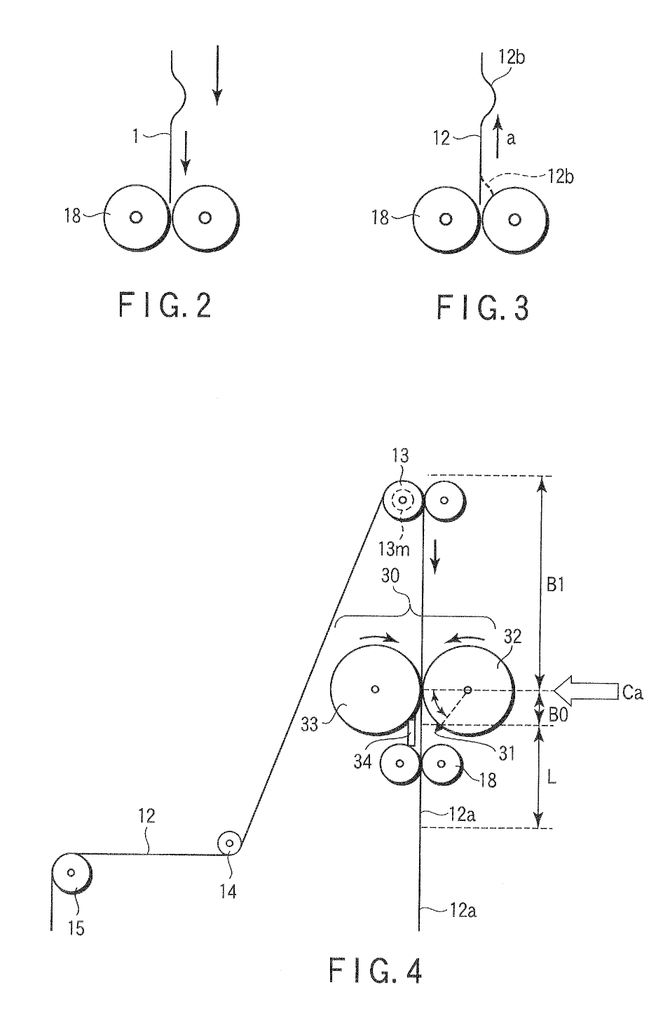

On the other hand, there is a case where a wind-kink is present in the vicinity of the midway of a cut sheet. 12a as shown in FIG. 2. In this case, the forefront part of the cut sheet 12a is riot bent, and hence the cut sheet 12a traces the nip-line of the ejection roller pair 18 to be normally ejected. That is, the jam resistance performance at the rollers 18, and the like on the downstream side of the cutter 17 is determined according to the position at which the wind-kink of the cut sheet 12a is located with respect to the length in the transfer direction of the cut sheet 12a.

However, assuming that the web path length between the cutter 17 and first roller pair 13 is B1, web path length between the first roller pair 13 and second roller 14 is B2, and web path length between the second roller 14 and third roller 15 is B3, the web path lengths from the cutting position C of the cutter 17 in the standby state to the first to third rollers 13 to 15, i.e., the web path lengths from the first to third rollers 13 to 15 to the distal end of the web 12 become B1, B1+B2, and B1+B2+B3, respectively.

Accordingly, the first roller pair 13, second roller 14, and third roller 15 are arranged in such a manner that all the web path lengths B1, B1+B2, and B1+B2+B3 from the cutting position C of the cutter 17 to the first to third rollers 13 to 15 become the lengths offset from integer (n) multiples of the minimum cut lengths L. It is desirable that the first roller pair 13, second roller 14, and third roller 15 be arranged in such a manner that the offset value becomes a length obtained by dividing the minimum cut length L by a predetermined number m, for example, 2. The minimum cut length L is a length of a short side of a regular size, for example, the paper size A4 or the like. That is, the respective web path lengths from the cutting position C of the cutter 17 to the first, second, and third rollers 13, 14, and 15 are expressed by the following formulas (1).

B1=n·L+L(1/m)

B1+B2=n·L+L(1/m)

B1+B2+B3=n·L+L(1/m) (1)

When rollers other than the first to third rollers 13 to 15 are additionally arranged, the respective web path lengths from the cutting position C of the cutter 17 to the other rollers become B1+B2+B3+B4, B1+B2+B3+B4+B5, . . . , and B1+B2+B3+B4+B5+ . . . +Bn.

The other rollers are arranged in such a manner that all the respective web path lengths from the cutting position C to the other rollers B1+B2+B3+B4, B1+B2+B3+B4+B5, . . . , and B1+B2+B3+B4+B5+ . . . +Bn become the lengths offset from integral multiples of the minimum cut lengths L, and preferably the offset value becomes a length of half the minimum cut length L.

The offset value is not limited to the length of half the minimum cut length L, and may be the other length such as one fourth of the minimum out length L or the like.

As described above, according to the first embodiment, the first roller pair 13, second roller 14, and third roller 15 are arranged in such a manner that all the respective web path lengths B1, B1+B2, and B1+B2+B3 from the cutting position C of the cutter 17 to the first roller pair 13, second roller 14, and third roller 15 become the lengths offset from integer (n) multiples of the minimum t lengths L. As a result of this, the position of the wind-kink 12b on the web 12 is shifted by an amount corresponding to the offset as shown in FIG. 3. As a result of this, the position of the wind-kink 12b is present in the vicinity of the midway of the cut sheet 12a, and is not present on the distal end side of the cut sheet 12a.

As a result of this, it is possible to prevent, in advance, the cutting position C of the cutter 17 from coinciding with the wind-kink peaks 13a, 14a, and 15a of the first roller pair 13, second roller 14, and third roller 15. Furthermore, it is also possible to prevent, in advance, a jam on the downstream side of the cutter 17 resulting from wind-kinks caused by the first roller pair 13, second roller 14, and third roller 15 occurring in the standby state from occurring. It is possible to eliminate occurrence of a jam resulting from a wind-kink, and obtain excellent stability for the transfer and cutting of the web 12.

In the vicinity of the first roller pair 13 for applying transfer drive force to the web 12, the tension to be applied to the web 12 is the largest as compared with the other rollers, for example, the second roller 14, third roller 15, and the like. Accordingly, a wind-kink larger than those caused at, for example, the second roller 14, third roller 15, and the like is caused at the first roller pair 13.

In the case where jam occurrence resulting from wind-kinks caused at the rollers on the upstream side of the first roller pair 13, for example, the second roller 14, third roller 15, and the like does not matter much, and jam occurrence resulting from the first roller pair 13 is to be avoided, the first roller pair 13 is arranged in such a manner that at least only the length of the web path length B1 becomes a length offset from an integer (a) multiple of the minimum cut length L, and preferably the offset value becomes a length obtained by dividing the minimum cut length by m. As a result of this, it is possible to prevent, in advance, a wind-kink peak 13a caused by the first roller pair 13 or the like from being arranged at the cutting position C of the cutter 17. This makes it possible to eliminate occurrence of a jam resulting from a wind-kink.

The second roller is the smallest in radius of all the first to third rollers 13 to 15. A wind-kink caused at the second roller 14 exerts the largest influence on the jam in some cases. In such a case, the second roller 14 is arranged in such a manner that at least only the length (web path lengths B1+B2) becomes a length offset from an integer (n) multiple of the minimum cut length, and preferably the offset value becomes a length obtained by dividing the minimum cut length L by m. As a result of this, it is possible to prevent, in advance, the cutting position C of the cutter 17 from coinciding with the wind-kink peak 14a caused by the second roller 14. This makes it possible to eliminate occurrence of a jam resulting from a wind-kink.

Next, a second embodiment of the present invention will be described below with reference to the accompanying drawings. It should be noted that the same parts as those in FIG. 1 will be denoted by the same reference symbols as those in FIG. 1, and detailed description of them will be omitted.

FIG. 4 shows a main part of a web transfer apparatus. This apparatus 10 uses a rotary cutter (hereinafter referred to as a cutter) 30. The cutter 30 differs from the sheet cutter 17 in the method of cutting. The cutter 30 can continuously cut a web 12 into cut sheets 12a without temporarily stopping the transfer operation of the web 12. The cutter 30 is constituted of a cut roller 32, anvil roller 33, scraper 34 made of resin, and the like. The cut roller 32 includes a metallic drum, and cutting instrument (rotary cutting blade) 31 corresponding to the cut length formed on a surface of the metallic drum. The anvil roller 33 is a cylindrical metallic drum arranged to be opposed to the cut roller 32. The scraper 34 made of resin prevents a cut sheet 12a from being wound around the anvil roller 33. The position at which the cut roller 32 and anvil roller 33 are in contact with each other coincides with the cutting position Ca of the cutter 30. When the distal end of the cut sheet 12a is sent from the cutting position Ca of the cutter 30, the web path length between the cutting position Ca of the cutter 30 and distal end of the cut sheet 12a is defined as B0. When the length from the cutting position Ca of the cutter 30 to the first roller pair 13 is set as B1, the length from the distal end of the cut sheet 12a to first roller pair 13 is defined as the sum B0+B1 of the web path length B0 between the cutting position Ca of the cutter 30 and distal end of the cut sheet 12a, and the length B1 between the cutting position Ca of the cutter 30 and first roller pair 13.

Furthermore, the first roller pair 13, second roller 14, and third roller 15 are arranged in such a manner that all the respective web path lengths B0+B1, B0+B1+B2 and B0+B1+B2+B3 from the distal end position of the cut sheet 12a to the first roller pair 13, second roller 14, and third roller 15 become the lengths offset from integer (n) multiples of the minimum cut lengths L, and preferably the offset value becomes a length obtained by dividing the minimum cut length L by a predetermined number m. The minimum cut length L is a length of a long side of a regular size, for example, the paper size A4 or the like. That is, the respective web path lengths from the cutting position Ca of the cutter 30 to the first, second, and third rollers 13, 14, and 15 are expressed by the following formulas (2).

B0+B1=n·L+L(1/m)

B0+B1+B2=n·L+L(1/m)

B0+B1+B2+B3=n·L+L(1/m) (2)

As described above, according to the second embodiment described above, the first roller pair 13, second roller 14, and third roller 15 are arranged in such a manner that all the respective web path lengths B0+B1, B0+B1+B2, and B0+B1+B2+B3 from the distal end position of the cut sheet 12a to the first roller pair 13, second roller 14, and third roller 15 become the lengths offset from integer (n) multiples of the minimum cut lengths L. As a result of this, it is possible to prevent, in advance, the cutting position Ca of the cutter 30 from coinciding with the wind-kink peaks 13a, 14a, and 15a of the first roller pair 13, second roller 14, and third roller 15, like in the first embodiment. It is also possible to prevent, in advance, a jam on the downstream side of the cutter 30 resulting from wind-kinks caused by the first roller pair 13, second roller 14, and third roller 15 occurring in the standby state from occurring. It is possible to eliminate occurrence of a jam resulting from a wind-kink, and obtain excellent stability for the transfer and cutting of the web 12.

The other embodiments of the present invention will be described below.

Arrangement positions of first to third rollers 13 to 15 can be changed in such a manner that respective web path lengths B0+B1, B0+B1+B2, and B0+B1+B2+B3 become lengths offset from integer (n) multiples of the lengths L of the cut sheet 12a. For example, the length L of the cut sheet 12a differs in cut length depending on the regular size, for example, the paper size A4 or letter. Accordingly, the arrangement positions of the first to third rollers 13 to 15 are changed in accordance with the regular size or letter of the paper.

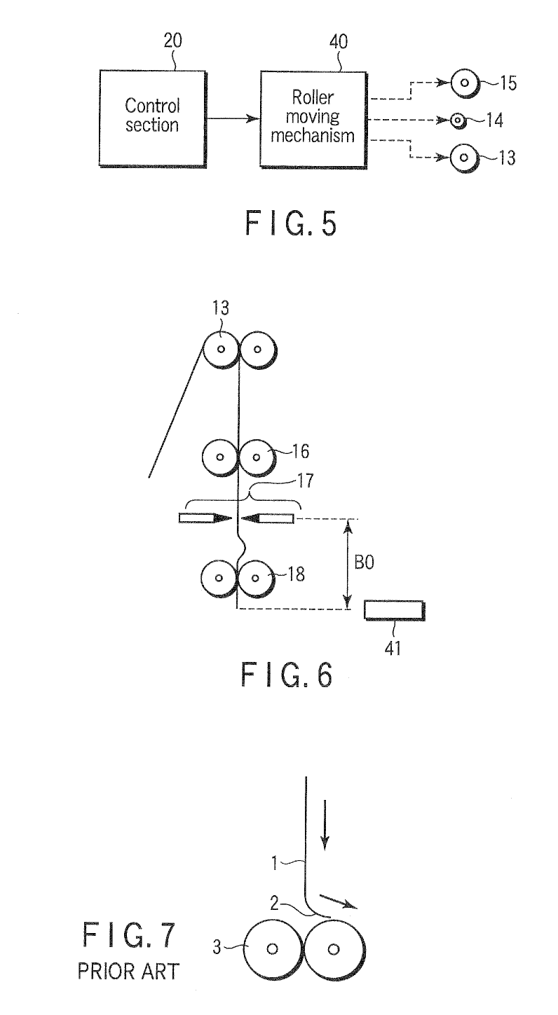

FIG. 5 shows an example of a mechanism which enables arrangement positions of first to third rollers 13 to 15 to be changed. A roller moving mechanism 40 is connected to a control section 20. The control section 20 issues an instruction to change the arrangement positions of the first to third rollers 13 to 15 In accordance with the regular size, e.g., the paper size A4 or the like to the roller moving mechanism 40. The roller moving mechanism 40 receives the instruction from the control section 20, and moves the first to third rollers 13 to 15. The first to third rollers 13 to 15 are respectively moved to the arrangement positions corresponding to the regular size, e.g., the paper size A4 or the like.

In the apparatus configured as described above, it is possible to automatically change the respective arrangement positions of the first to third rollers 13 to 15 in accordance with, for example, the paper size A4 or the like.

The arrangement positions of the first to third rollers may be configured changeable by the manual operation of the user.

Further, another embodiment will be described below.

In the first embodiment described previously, the first roller pair 13, second roller 14, and third roller 15 are arranged in such a manner that all the respective web path lengths B1, B1+B2, and B1+B2+B3 from the cutting position C of the cutter 17 to the first roller pair 13, second roller 14, and third roller 15 become the lengths offset from the integer (n) multiples of the minimum cut lengths L. In the second embodiment described previously, the first roller pair 13, second roller 14, and third roller 15 are arranged in such a manner that all the respective web path lengths B0+B1, B0+B1+B2, and B0+B1+B2+B3 from the distal end position of the cut sheet 12a to the first roller pair 13, second roller 14, and third roller 15 become the lengths offset from the integer (n) multiples of the minimum cut lengths L.

In each of the first and second embodiments, there is also this web transfer apparatus 10 in which the distal end of the web 12 in the standby state coincides with the cutting position C or Ca of the cutter 17 or 30. In the case of this web transfer apparatus 10, transfer of the web 12 is started from the standby state, the out length from the distal end of the web 12 at the time at which the web 12 is cut by the cutter 17 or 30 for the first time to the cutting position C or Ca of the cutter 17 or 30 is set at a length different from an integer (n) multiple of the length of the cut sheet 12a.

That is, the first cut length is shifted from the length of the cut sheet 12a. The cutting position C or Ca of the cutter 17 or 30 is shifted from the distal end of the cut sheet 12a. For example, the respective distances between, for example, the first to third rollers 13 to 15, and the cutting position C or Ca of the cutter 17 or 30 are set at integer (n) multiples of the minimum cut lengths L. The length of the first out sheet 12a is shifted to a length longer than the regular length by, for example, about 100 mm by delaying the cutting start timing of the cutter 17 or 30. The lengths of the second and subsequent cut sheets 12a are made the regular lengths. As a result of this, in the second and subsequent cut sheets 12a, it is possible to prevent the wind-kinks caused at the first to third rollers 13 to 15 from coinciding with the cutting position of the cutter 17 or 30.

In the first embodiment described previously, web distal-end sensor 41 may be provided as shown in FIG. 6. The web distal-end sensor 41 is provided on the downstream side of the cutting position C of the cutter 17 in the transfer direction of the out sheet 12a. The arrangement position of the web distal-end sensor 41 is set at a position separate from the cutting position C of the cutter 17 by the web path length BO corresponding to the length by which the distal end of the out sheet 12a has been transferred. The web distal-end sensor 41 detects the distal end of the web 12 cut by the cutter 17.

In the case where the web distal-end sensor 41 is provided, when the cutting of the web 12 is temporarily stopped and the apparatus is brought into the standby state, the control section 20 rotation-drives the first roller pair 13, and transfers the web 12 until the distal end thereof is detected by the web distal-end sensor 41. As a result of this, as for the arrangement positions of the first roller pair 13, second roller 14, and third roller 15, it is possible to offset all the respective web path lengths B0+B1, B0+B1+B2, and B0+B1+B2+B3 from the distal end position of the cut sheet 12a to the first roller pair 13, second roller 14, and third roller 15 from the integer (n) multiples of the minimum cut lengths L.

Even when the arrangement position of the web distal-end sensor 41 is on the upstream side of the cutter 17, the same effect can be obtained. In the case where the web distal-end sensor 41 is provided on the upstream side of the cutter 17, when the cutting of the web 12 is temporarily stopped, and the apparatus is brought into the standby state, the control section 20 rotation-drives the first roller in the reverse rotational direction, and transfers the web 12 until the distal end thereof is detected by the web distal-end sensor 41.

In the first embodiment described above, the unwinding section 11 may be not only made to send off the web 12, but also made possible to rewind the web 12. In this case, the apparatus 10 cuts the web 12 into sheets of the regular paper size such as the paper size A4 or the like by means of the cutter 17, and thereafter rewinds the web 12 to shift to the standby state.

In the apparatus 10, the distal end position of the web 12 in the standby state is set in such a manner that the respective web lengths from the first roller pair 13, second roller 14, and third roller 15 in the standby state to the distal end of the web 12 become the lengths offset from integral multiples of the lengths of the cut sheets 12a to be cut in units of regular sizes. More specifically, in the apparatus 10, all the respective web path lengths B0+B1, B0+B1+B2, and B0+B1+B2+B3 from the distal end position of the cut sheet 12a in the standby state to the first roller pair 13, second roller 14, and third roller 15 are made to become the lengths offset from the integer (n) multiples of the sheet lengths of the regular paper size such as the paper size A4. It is not indispensable to provide the unwinding section 11 with the function of rewinding the web 12. After cutting the web 12, the unwinding section 11 further sends off the web 12. As a result of this, it is also possible to make all the respective web path lengths from the distal end position of the cut sheet 12a to the second roller 14, and third roller 15 which are positioned on the upstream side of the first roller pair 13 for carrying out wind-drive become the lengths offset from the integer (n) multiples of the sheet lengths of the regular paper size such as the paper size A4 or the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A web transfer apparatus comprising:
an unwinding section configured to unwind a web wound into a roll-shape;
a transfer roller section configured to transfer the web on a predetermined web transfer path;
a wind-roller section configured to change a transfer direction of the web by winding the web along the surface thereof;
a cutter arranged on a downstream side of the arrangement position of the wind-roller section on the web transfer path, and configured to cut the web in units of regular sizes; and
a web transfer control section configured to drive-control the unwinding section, transfer roller section, wind-roller section, and cutter,
wherein:
the wind-roller section and cutter are arranged in such a manner that an interval corresponding to a length offset from a length of an integral multiple of a length of a cut sheet cuts in units of the regular sizes.

2. The web transfer apparatus according to claim 1, wherein
the wind-roller section includes a tension roller configured to apply tension to the web.

3. The web transfer apparatus according to claim 1,
wherein:
the wind-roller section includes a plurality of wind-rollers provided at a plurality of positions on the web transfer path and including a wind-roller which is the smallest in roller diameter of all the plurality of wind-rollers.

4. The web transfer apparatus according to claim 1,
wherein:
the wind-roller section includes a plurality of wind-rollers provided at a plurality of positions on the web transfer path, including a wind-roller among the plurality of wind-rollers, arranged on the upstream side of an arrangement position of the cutter in the web transfer direction, and arranged closest to the cutter.

5. The web transfer apparatus according to claim 1,
wherein:
the wind-roller section includes respective wind-rollers provided at a plurality of positions on the web transfer path, and
the respective wind-rollers and cutter are arranged with intervals held between the wind-rollers and cutter in such a manner that the respective web lengths from the respective wind-rollers to a cutting position of the cutter correspond to lengths offset from lengths of integral multiples of the lengths of the cut sheets.

6. The web transfer apparatus according to claim 1,
wherein:
the wind-roller section includes a plurality of wind-rollers provided at a plurality of positions on the web transfer path and including a wind-roller a web-wind-angle of which is the largest of all the plurality of wind-rollers.

7. A web transfer apparatus comprising:
an unwinding section configured to unwind a web wound into a roll-shape;
a transfer roller section configured to transfer the web on a predetermined web transfer path;
a wind-roller section configured to change a transfer direction of the web by winding the web;
a cutter arranged on the downstream side of the arrangement position of the wind-roller section on the web transfer path, and configured to cut the web in units of regular sizes;
a web transfer control section configured to drive-control the unwinding section, transfer roller section, wind-roller section, and cutter; and
a roller moving mechanism configured to change the arrangement position of the wind-roller section in such a manner that an interval between the wind-roller section and cutter becomes a length offset from a length of an integral multiple of a length of a cut sheet cut in units of the regular sizes.

8. The web transfer apparatus according to claim 7,
wherein:
the wind-roller section includes a tension roller configured to apply tension to the web.

9. The web transfer apparatus according to claim 7,
wherein:
the wind-roller section includes a plurality of wind-rollers provided at a plurality of positions on the web transfer path, and is a wind-roller which is the smallest in roller diameter of all the plurality of wind-rollers.

10. The web transfer apparatus according to claim 7,
wherein:
the wind-roller section includes a plurality of wind-rollers provided at a plurality of positions on the web transfer path and including a wind-roller among the plurality of wind-rollers, arranged on the upstream side of an arrangement position of the cutter in the web transfer direction, and arranged closest to the cutter.

11. The web transfer apparatus according to claim 7,
wherein:
the wind-roller section includes respective wind-rollers provided at a plurality of positions on the web transfer path, and
the respective wind-rollers and cutter are arranged with intervals held between the wind-rollers and cutter in such a manner that the respective web lengths from the respective wind-rollers to a cutting position of the cutter correspond to lengths offset from lengths of integral multiples of the lengths of the cut sheets.

12. The web transfer apparatus according to claim 7,
wherein:
the wind-roller section includes a plurality of wind-rollers provided at a plurality of positions on the web transfer path and including a wind-roller a web-wind-angle of which is the largest of all the plurality of wind-rollers.

13. A web transfer apparatus comprising:
an unwinding section configured to unwind a web wound into a roll-shape;
a transfer roller section configured to transfer the web on a predetermined web transfer path;
a wind-roller section configured to change a transfer direction of the web by winding the web;
a cutter arranged on the downstream side of the arrangement position of the wind-roller section on the web transfer path, and configured to out the web in units of regular sizes; and
a web transfer control section configured to drive-control the unwinding section, transfer roller section, wind-roller section, and cutter,
wherein:
a distal end position of the web in the standby state is set in such a manner that a web length from the wind-roller section in the standby state to the distal end of the web becomes a length offset from a length of an integral multiple of a length of a cut sheet cuts in units of the regular sizes.

14. The web transfer apparatus according to claim 13,
wherein:
the wind-roller section includes a tension roller configured to apply tension to the web.

15. The web transfer apparatus according to claim 13,
wherein:
the wind-roller section includes a plurality of wind-rollers provided at a plurality of positions on the web transfer path and including a wind-roller which is the smallest in roller diameter of all the plurality of wind-rollers.

16. The web transfer apparatus according to claim 13,
wherein:
the wind-roller section includes a plurality of wind-rollers provided at a plurality of positions on the web transfer path and including a wind-roller among the plurality of wind-rollers, arranged on the upstream side of an arrangement position of the cutter in the web transfer direction, and arranged closest to the cutter.

17. The web transfer apparatus according to claim 13,
wherein:
the wind-roller section includes respective wind-rollers provided at a plurality of positions on the web transfer path, and
the respective wind-rollers and cutter are arranged with intervals held between the wind-rollers and cutter in such a manner that the respective web lengths from the respective wind-rollers to a cutting position of the cutter correspond to lengths offset from lengths of integral multiples of the lengths of the cut sheets.

18. The web transfer apparatus according to claim 13,
wherein:
the wind-roller section includes a plurality of wind-rollers provided at a plurality of positions on the web transfer path, and include a wind-roller a web-wind-angle of which is the largest of all the plurality of wind-rollers.
